(19) United States
(12) Patent Application Publication
(10) Pub. No.: US 2011/0153969 A1
(43) Pub. Date: Jun. 23, 2011

(54) DEVICE AND METHOD TO CONTROL COMMUNICATIONS BETWEEN AND ACCESS TO COMPUTER NETWORKS, SYSTEMS OR DEVICES

(76) Inventor: William Petrick, Nipomo, CA (US)

(21) Appl. No.: 12/858,124

(22) Filed: Aug. 17, 2010

Related U.S. Application Data
(60) Provisional application No. 61/287,796, filed on Dec. 18, 2009.

(51) Int. Cl. G06F 21/00; G06F 12/14

(52) U.S. Cl. 711/163; 726/12; 711/E12.091

(57) ABSTRACT

A network security device and method for one way or secure communication are disclosed. At least one processor is connected to a higher level network port and a lower level network port, and is connectable to a shared memory. The at least one processor is configured to send a data to the lower level network port via the shared memory in response to receiving the data from the higher level network port and to decline or ignore any request from the lower level network port to write to the shared memory. The at least one processor, which may be a higher level processor, may be further configured to decline or ignore any request from the higher level network port to read the shared memory. A lower level processor, connected to the lower level network port, may be at least conditionally disabled from writing to the shared memory.

### CROSS-REFERENCE TO RELATED APPLICATION

This application claims priority from U.S. provisional application No. 61/287,796, filed Dec. 18, 2009.

### TECHNICAL FIELD

The present invention relates generally to data communication in a network and more specifically to controlling the flow of communications and data between and access to computer networks, systems and devices, especially one way communication flow.

### BACKGROUND

Controlling the flow of communications and data between and access to computer networks, systems, devices, etc. to provide proper security is becoming increasingly important. Especially important is not only whether or not a computer system or device may communicate with another computer network, system or device but whether it is even physically possible for this communication to occur. Also, communication may need to be directionally restricted. For example, when only one way communication is allowed, a first computer network, system or device can send data to a second computer system or device but the second computer network, system or device can not send data to the first communication network, system or device.

Securely controlling the flow of data between and access to computer networks, systems, or devices is applicable to many communication situations. These situations may include communication, data flow, and access between networks, internal to networks, between a computer and various peripheral devices, wireless network and communications such as satellite, WIFI, Bluetooth etc., and especially the restrictions relating to the nuclear industry as found in the Code of Federal Regulations (CFR) 10 CFR 73.54 and the Nuclear Regulatory Commission (NRC) Regulatory Guide 5.71. Other industry regulatory agencies have adopted similar standards. For example, the Federal Energy Regulatory Commission (FERC) has adopted a set of Critical Infrastructure Protection (CIP) reliability standards that address cyber-security issues.

Existing one-way communications links between separated and independent computing systems generally use hardware to implement a one-way communications path. In one example, a known system uses RS232 hardware in which the receive line (Rx) is disconnected from the higher level device, thereby preventing any data communication to the device. The transmit line is still active, thereby allowing data to be sent to another device on a lower level. This “hardware” solution has many limitations that need to be overcome in order to provide a highly reliable data communications link, such as how to include custom software and data protocols to detect transmission errors and provide flexibility. Furthermore, the data rates for these types of links are slow, which limits the amount of data that can be passed.

For example, U.S. published Patent Application No. 20080259929 to Mraz describes secure one-way data transfer between computers over a data link such as optical fiber or shielded twisted pair copper wire communication cable etc. The circuitry is configured to only send data in one direction. Although this establishes one-way communication, it may not establish two communications or control the access of the one-way communication. It establishes all-or-nothing communication through hardware configuration.

Also, U.S. published Patent Application No. 2008/0008207 to Kellum describes a one-way data or communication link. A connector is reconfigured to allow only one-way communication and a device driver is altered to allow the one-way signal path to function as a normal communications link for one-way data transfers. As with the Mraz application, it establishes all-or-nothing communication through hardware configuration.

Also, U.S. published Patent Application No. 2005/0033990 to Harvey et al. describes network security provided by a secure one-way data transfer mechanism. A mechanism is provided that either transmits or receives unidirectionally across a network boundary (e.g., a network security boundary by using a transmitter and/or receiver that is capable only of unidirectional communication across a network boundary (e.g., via a unidirectional conduit), there is no danger that data signals might travel in an unintended and/or an undesirable direction across a network boundary.

A better way is needed to provide control of communications and data flow between and access to computer networks, systems or devices, especially when only one way communications are required.

### SUMMARY

A device and method are herein presented as meeting objectives of providing control of communications and data flow between and access to computer networks, systems or devices, especially one way communications. A network security device and method for one-way or secure communications between digital assets at different security levels are disclosed. The method allows standard two-way protocols (such as TCP/IP, UDP, MODBUS) to operate in a cyber-security network. An instantiation of the method may be embodied in a device in which at least one processor is connected to a higher level network port and a lower level network port, and is connectable to shared memory with access control corresponding to the security levels of the connected digital assets.

In a first example, a network security device has a higher level network port connectable to a first network, in order to communicate with a higher level digital asset. A lower level network port is connectable to a second network, in order to communicate with a lower level digital asset. The device has at least one processor connected to the higher level network port and to the lower level network port. The at least one processor is connectable to a shared memory. The at least one processor is configured to send a data to the lower level network port via the shared memory in response to receiving the data from the higher level network port. The at least one processor is further configured to decline any request from the lower level network port to the at least one processor to write to the shared memory. The at least one processor may be further configured to decline any request from the higher level network port to read the shared memory.

In a second example, a network security device has a higher level network port connectable to a first network. A lower level network port is connectable to a second network. A higher level processor is connected to the higher level network port and to a shared memory. A lower level processor is connected to the lower level network port and to the shared memory. The lower level processor is at least conditionally disabled from writing to the shared memory. The higher level processor and the lower level processor are configured to receive a data at the higher level processor from a higher level network port. The higher level processor and the lower level processor are further configured to write the data from the higher level processor to the shared memory in response to receiving the data from the higher level network port at the higher level processor. The higher level processor and the lower level processor are still further configured to read the data from the shared memory to the lower level processor in response to the data being written to the shared memory by the higher level processor. The higher level processor and the lower level processor are still further configured to send the data from the lower level processor to the lower level network port in response to reading the data from the shared memory to the lower level processor. The higher level processor may be further configured to ignore any request from the higher level network port to the higher level processor to read the shared memory.

In a third example, a method for one way communication in a computer network is operable on at least one processor. Data is received at the at least one processor, from a higher level network port. The data is sent from the at least one processor to a lower level network port in response to receiving the data at the at least one processor. Any request from the lower level network port to the at least one processor to write to a shared memory is ignored. At least one of receiving the data or sending the data is via the shared memory. An act of ignoring any request from the higher level network port to the at least one processor to read the shared memory may be added to the method.

In a fourth example, a method for securely controlling communications in a computer network is operable on a higher level processor and a lower level processor. Data is received at the higher level processor from a higher level network port. The data is written from the higher level processor to a shared memory in response to receiving the data at the higher level processor. The data is read from the shared memory to the lower level processor in response to the data being written to the shared memory by the higher level processor. The data is sent from the lower level processor to a lower level network port in response to reading the data to the lower level processor. Any request from the lower level network port to the lower level processor to write to the shared memory is declined. An act of declining any request from the higher level network port to the higher level processor to read the shared memory may be added to the method.

A memory write disable circuit may be applied in various examples, to prevent or disable a lower level task or a lower level processor from writing to the shared memory. A write line from the at least one processor or from the lower level processor may be gated by a port bit or other software controllable line, which is set or cleared to enable or disable writing to the shared memory.

Various illustrative embodiments of the network security device and method provide scalable, reliable, versatile, flexible, and adaptable security with which to control the flow of communications and data between and access to computer networks, systems, devices or other critical digital assets (CDAs). The present invention may, among other things, establish communications restrictions relating to the nuclear industry as found in the Code of Federal Regulations (CFR) 10 CFR 73.54 and the Nuclear Regulatory Commission (NRC) Regulatory Guide 5.71.

The network security device and method implement a type of memory bridge, which is a device through which communication occurs and access may be managed. In a network, security levels are assigned to various CDAs. A memory bridge is placed between and connected to selected CDAs. The memory bridge contains, among other things, memory segments which correspond to security levels. CDAs of a specific security level have complete access to the memory segment of the corresponding security level. Communications and access between the memory segments of different security levels are regulated by an access controller. The access controller, through the use of access control software, regulates the flow of communications between memory segments and the access privileges and rights that CDAs of one level may have with the CDAs of another level. By controlling data flow and access between memory segments, data flow and access between security levels and hence the CDAs are controlled. In addition to regulating the directional flow of data, the access controller may regulate types of access or privileges allowed between different security levels, such as instituting access control lists (ACLs). Thus control is established through software.

The memory bridge may be used in conjunction with bridges, routers, hubs, gateways, switches, etc. It may be used to separate divisions of a company or to establish firewalls. The memory bridge may be installed between computers, computer systems, devices, networks, network segments, etc. The memory bridge may have a plurality of memory segments for a plurality of security levels which may correspond to a plurality of CDAs. The memory bridge may connect to CDAs by using various transmission media such as, but not limited to, cable and wireless media.

The network security device and method of FIGS. 1-10 provide scalable, reliable, versatile, flexible, and adaptable security to control the flow of communications and data between and access to computer networks, systems, or devices etc. A general overview of security levels and concepts relating to a memory bridge is followed by data flow details and discussion of a memory bridge and a data diode. Examples and variations of the network security device and method are presented throughout the disclosure.

The various computer networks, systems or devices etc. to which the network security device and method are applicable are referred to as critical digital assets (CDAs). The CDAs may include but are not limited to networks, network segments, servers, computers, various computer devices, routers, hubs, bridges, printers, etc. The CDAs are also categorized by levels. The levels are effectively security levels which denote security requirements applicable to the CDAs. Levels are given numbers where higher numbered levels have greater security requirements than lower numbered levels.

A memory bridge is a device placed between CDAs such that any communication between or access to CDAs must pass through the memory bridge. The CDAs may be connected to the memory bridge by any of the transmission media known in the art. The transmission media may include, but not be limited to, wire media, such as twisted pair cable, coaxial cable, etc., optical media, such as fiber optic cable, wireless media employing the electromagnetic spectrum such as satellite, microwave, infrared, Wi-Fi™, Bluetooth®, etc. The transmission protocols used may be any of those known in the art such as RS232, USB, TCP/IP, etc. Since the various transmission media and transmission protocols are well known in the art, they need not be further discussed.

The memory bridge may be used in conjunction with bridges, routers, hubs, gateways, switches, etc. It may be used to separate divisions of a company or to establish firewalls. The memory bridge may be installed between computers, computer systems, devices, networks, network segments, etc. The memory bridge may have a plurality of memory segments for a plurality of security levels which may correspond to a plurality of CDAs. The memory bridge may connect to CDAs by using various transmission media such as, but not limited to, cable and wireless media.

The memory bridge is controlled by the unique use of microprocessor-based protections that are setup and controlled by a highly reliable real-time operating system (RTOS). The microprocessor-based protections are part of memory bridge software that control communications and data flow between CDAs, access and access privileges to CDAs, and any other security requirements that may be needed. The memory bridge software may be controlled by an RTOS executing on the memory bridge or may execute as embedded software in the memory bridge. The memory bridge may use commercially available off-the-shelf microprocessors, associated peripheral chips, hardware components, software components, RTOSs, etc. Custom software may be used when needed, for example, with legacy CDAs which may contain non-standard interfaces. Control is established while allowing the use of standard two-way communications protocols on each side of the memory bridge.

The memory bridge contains segmented portions of memory, where a segmented portion of memory is designated for a specific level. The segmented portions of memory will be referred to as memory segments. Communications and access between the memory segments of different security levels are regulated by an access controller. The access controller, through the use of access control software, regulates the flow of communications between memory segments and the access privileges and rights that CDAs of one level may have with the CDAs of another level. By controlling data flow and access between memory segments, data flow and access between security levels and hence the CDAs are controlled. In addition to regulating the directional flow of data, the access controller may regulate types of access or privileges allowed between different security levels, such as instituting access control lists (ACLs). Thus control is established through software.

The memory bridge software allows CDAs to only access allowed memory segments appropriate to its level, as required by security needs. In addition, the memory bridge software may control read, read/write, and execute permissives for privileged and non-privileged users and CDAs (i.e. the higher level and lower-level users and CDAs respectively). Furthermore, to protect the microprocessor from cyber attacks, the privileged users may also have register and interrupt protections. Rules for access to CDAs include but are not limited to: CDAs of a particular level can read or write to memory segments assigned to CDAs assigned to that same particular level; CDAs can write to memory segments assigned to CDAs of lower levels; and CDAs have no access to memory segments assigned to CDAs of higher levels, not even read access.

Generally a CDA of a higher level is allowed to push communications from its memory segment to the memory segment of a CDA at a lower level. In an alternate example a CDA of a lower level may pull communications from the memory segment of a higher level CDA to its memory segment. In another alternate example there may be a combination of pushing and pulling. In some examples CDAs of a specific level may share a common memory segment.

### BRIEF DESCRIPTION OF THE DRAWINGS

FIG. 1 is a high-level configuration diagram of allowed directions of communications data flow between levels of computer systems or devices.

FIG. 2 is a diagram of a memory bridge providing data flow in accordance with FIG. 1.

FIG. 3 is a block diagram of a data diode providing a memory bridge in accordance with FIG. 2 and data flow in accordance with FIG. 1.

FIG. 4 is a block diagram of a variation of the data diode of FIG. 3, with a dual Ethernet port chip.

FIG. 5 is a block diagram of a further variation of the data diode of FIG. 3, with a single chip CPU having two Ethernet ports.

FIG. 6 is a block diagram of a still further variation of the data diode of FIG. 3, as a bus-based device.

FIG. 7 is a flow diagram of a Higher Level HOST task, suitable for the data diodes of FIGS. 3-6.

FIG. 8 is a flow diagram of a Higher Level Shared Memory task, suitable for the data diodes of FIGS. 3-6.

FIG. 9 is a flow diagram of a Lower Level Shared Memory task, suitable for the data diodes of FIGS. 3-6.

FIG. 10 is a flow diagram of a Lower Level HOST task, suitable for the data diodes of FIGS. 3-6.

### DETAILED DESCRIPTION

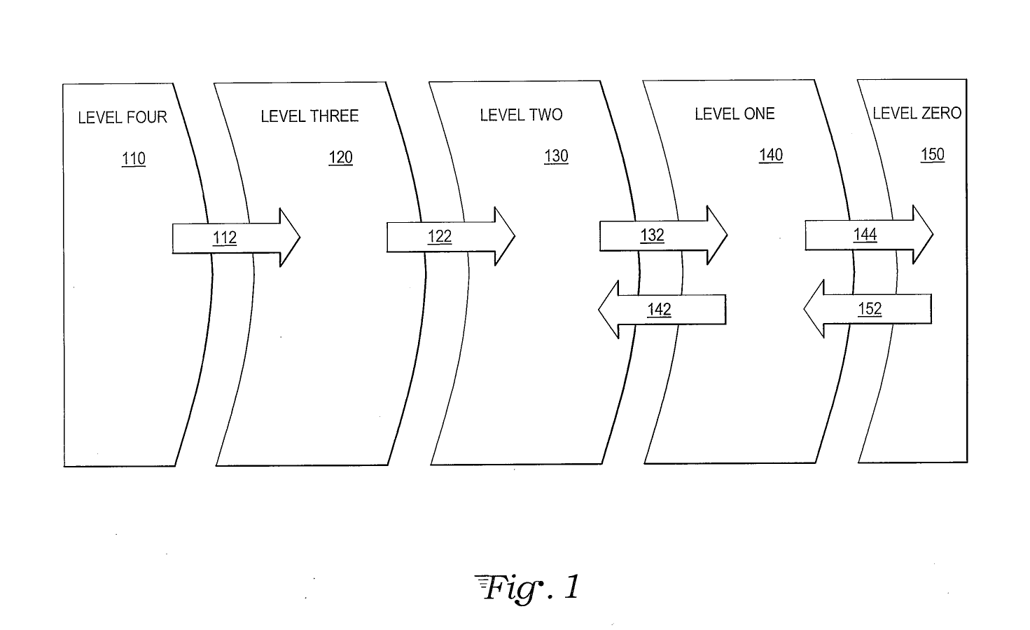

With reference to FIG. 1, an example is given of controlled direction of data flow and access to CDAs. There are five levels shown in FIG. 1 which apply to five separate CDAs, one CDA per level. The levels are; level four 110, level three 120, level two 130, level one 140, and level zero 150. CDAs assigned to level four 110 require higher security and CDAs assigned to level zero 150 require lower security. The direction of allowed communications and access between the CDAs of the various levels are shown by arrows 112, 122, 132, 142, 144, and 152.

Arrow 112, indicates that CDAs of level four 110 may communicate to and have access to CDAs of level three 120. There is no arrow pointing to level four 110 from level three 120 indicating a one way flow of communication and access from CDAs of level four 110 to CDAs of level three 120. In this example, there is only one way communication and access between level four 110 and level three 120. Level three 120 has no access to level four 110.

Arrow 122, indicates that CDAs of level three 120 may communicate to and have access to CDAs of level two 130. There is no arrow pointing to level three 120 from level two 130 indicating a one way flow of communication and access from CDAs of level three 120 to CDAs of level two 130. In this example, there is only one way communication and access from level three 120 and level two 130. Level two 130 has no access to level three 120.

Arrow 132 and arrow 142 indicate that CDAs of level two 130 and CDAs of level one 140 have two way communication and access between each other. Arrow 144 and arrow 152 indicate that CDAs of level one 140 and CDAs of level zero 150 also have two way communication and access between each other.

Arrows may point in any direction and need not be limited to connecting consecutively numbered levels or just two levels. The direction of data flow and access embodied in FIG. 1 is particularly suited, although by no means limited to, the communications restrictions relating to the nuclear industry as found in the Code of Federal Regulations (CFR) 10 CFR 73.54 and the Nuclear Regulatory Commission (NRC) Regulatory Guide 5.71.

The example of FIG. 1 provides a cybersafe communications link between CDAs of adjoining levels as defined in the cybersecurity defensive model of the Nuclear Regulatory Commission (NRC) Regulatory Guide 5.71. In a nuclear plant, level four 110 may be control and protection systems that control some aspect of power operations, level three 120 may be data acquisition and monitoring systems with no control functions, level two 130 may be business or corporate systems that support operations, level one 140 and level zero 150 may be uncontrolled LANs, Internet, etc.

The example of FIG. 1 is merely one example. Alternate examples may have a level connected directly to several other levels, in a plurality of configurations, and not to only one or two levels as embodied in FIG. 1.

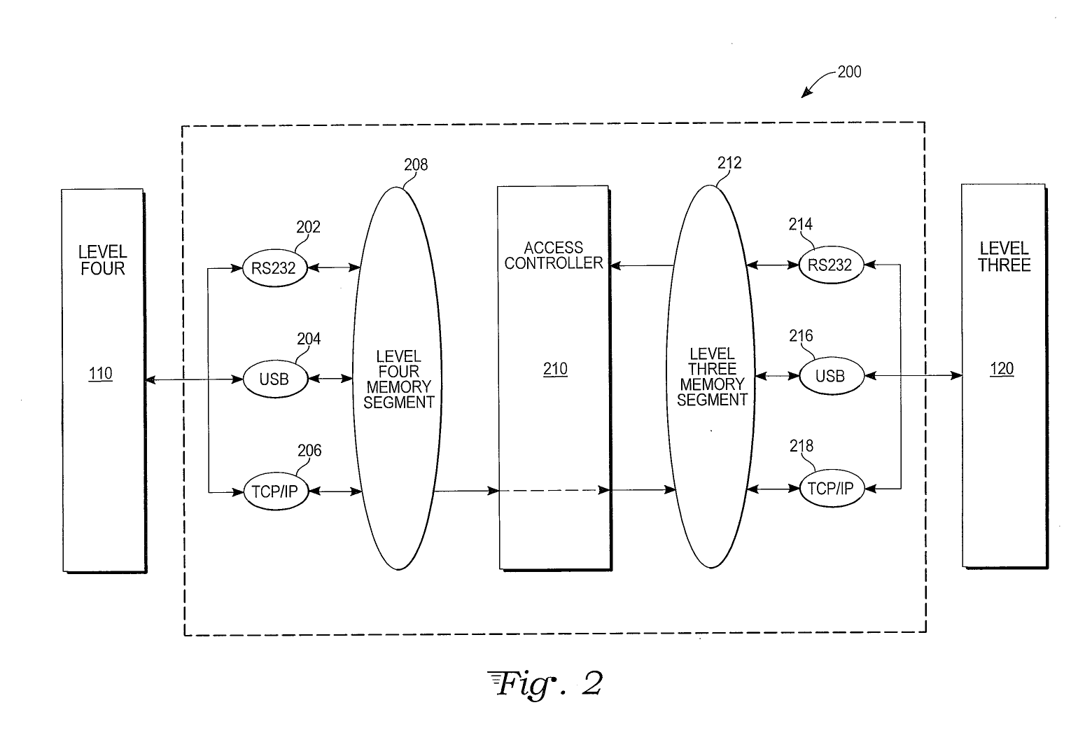

With reference to FIG. 2, an example of a memory bridge 200 provides one way directional control as indicated by arrow 112 of FIG. 1. Memory bridge 200 is physically placed between CDAs of level four 110 and level three 120 in such a manner that any communication or access between CDAs of level four 110 and level three 120 must pass through memory bridge 200. A memory bridge need not be restricted to CDAs of two levels and two corresponding memory segments. In alternate examples, memory bridge 200 may connect CDAs of a plurality of levels where each level has its own corresponding memory segment. In other examples each CDA or groups of CDAs of the same level may have a separate memory segment etc.

Memory bridge 200 contains level four memory segment 208 which connects to CDAs of level four 110 through the use of software regulators. In this example, the software regulators are RS232 202, USB 204, and TCP/IP 206. Memory bridge 200 also contains level three memory segment 212 which connects to CDAs of level three 120 through software regulators. In this example the software regulators are RS232 214, USB 216, and TCP/IP 218. Other software regulators may be included which correspond to other transmission media or protocols. The software regulators perform the sending and receiving of data between CDAs of a level and the level's corresponding memory segment, data conversion (if any), and storage in the corresponding memory segment. The software regulators are controlled and scheduled by the RTOS (not shown). Memory bridge 200 also contains access controller 210 which effectively controls communication and access between CDAs of level four 110 and CDAs of level there 120 by controlling communication and access between level four memory segment 208 and level three memory segment 212. Access controller 210 provides data flow and access control through the use of access control software (not shown). The access control software may be controlled by an RTOS of or executing in a higher level CDA, in some examples an RTOS of or executing in a lower level CDA, an RTOS of or executing in the memory bridge, or the access control software may execute as embedded software in the memory bridge, etc. Security, control, and separation between levels are accomplished by software rather than hardware.

For this example, CDAs of each level have unrestricted access to its corresponding memory segment. CDAs of level four 110 have complete access to level four memory segment 208 and CDAs of level three 120 have complete access to level three memory segment 212. Data flow between memory segments and the ability of one memory segment to access another memory segment is controlled by the access control software associated with the access controller.

Memory bridge 200 allows only one way data flow and access from level four memory segment 208 to level three memory segment 212. When level four memory segment 208 attempts to send data to level three memory segment 212, access controller 210 allows the data to be received by level three memory segment 212. If level three memory segment 212 attempts to send data to level four memory segment 208 access controller 210 prohibits the receipt of the data by level four memory segment 208. In addition access controller 210 may prohibit level three memory segment 212 from even reading anything stored in level four memory segment 208. In this example, the higher level is allowed to successfully push data to and access the lower level memory segment but the lower level is prohibited from successfully pushing data to, pulling data from or otherwise accessing the higher level memory segment.

In addition to the sending and receiving of data, access controller 210 may apply a plurality of security and access restrictions between levels. Security and access restrictions are well known in the art for example, an access control list (ACL). An ACL may define the permissions or rights that users, groups, processes, networks, systems, devices, CDAs, etc. have for accessing resources, CDAs, systems, devices, networks, etc. Permissions may include, but not be limited to read access, read/write access, no access, execution access, etc. Access control is well known in the art and need not be discussed further.

Memory bridge 200 describes, as does FIG. 1, a cybersafe communications link between adjoining levels as defined in the cybersecurity defensive model of the Nuclear Regulatory Commission (NRC) Regulatory Guide 5.71.

A memory bridge, as discussed above need not be limited to two CDAs, CDAs of two levels, or two memory segments. In an alternate example, the memory bridge may connect a plurality of levels and a plurality of CDAs where each level has its own corresponding memory segment. Just one example is a wireless computer system with wireless peripheral devices. The host computer and the peripheral devices are CDAs to which appropriate levels are assigned. In this example, the memory bridge has separate memory segments for each level and the separate memory segments are separated by an access controller. As described above, CDAs of each level have complete access to the level's corresponding memory segment and access between memory segments is controlled by an access controller.

There are numerous alternate examples, uses, and configurations for which the memory bridge may be used. CDAs of the same level may have their own memory segment, be grouped where the groups have their own memory segment etc. There may be a plurality of configurations of CDAs, memory segments, or memory bridges. The memory bridge in its various configurations may be used internally or externally in conjunction with bridges, routers, hubs, gateways, switches, etc. It may be used to separate divisions of a company or to establish firewalls. The memory bridge may be installed between computers, computer systems, devices, networks, network segments, etc.

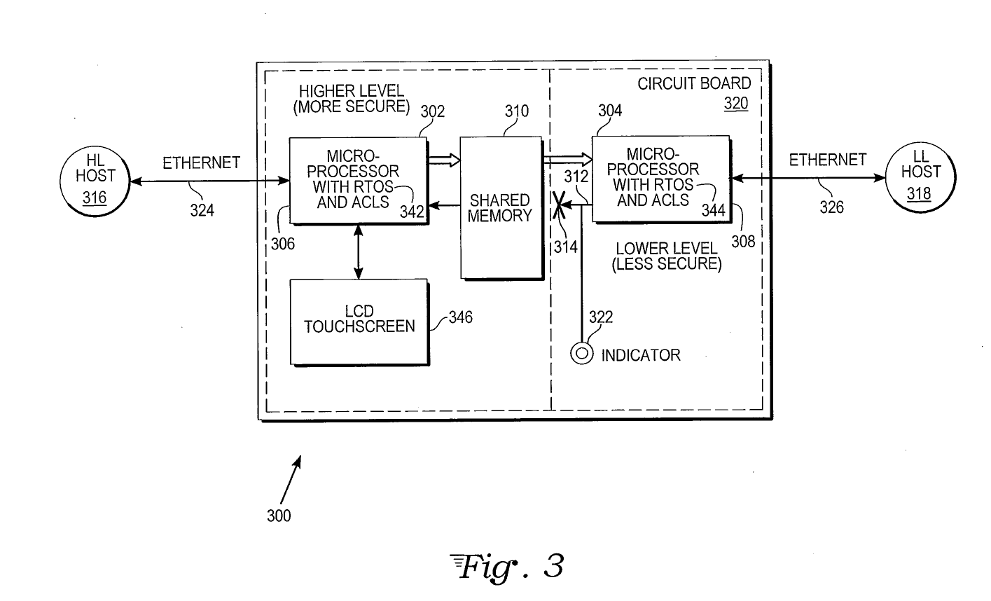

With reference to FIG. 3, an electronic data diode device (eDD) 300 implements a memory bridge in accordance with FIG. 2, and has allowed directions of communications data flow between levels of computer systems or devices as shown in FIG. 1. The electronic data diode 300 or eDD is suitable for cyber-security applications.

The design of the data diode device 300 uses software and hardware to control access to a shared memory bridge between different levels of the defensive model defined in the US Nuclear Regulatory Guide 5.71. Furthermore, the eDD design includes a defense-in-depth strategy that assures a one-way communication path which eliminates the possibility of a cyber-security attack from a lower level to a higher level digital asset. Variations of the data diode may use microprocessors, microcontrollers or other controllers or processors, single chip, single board, multichip, multiple board, off-the-shelf, custom logic, commercially available or custom modules and other components, along with software, firmware, hardwiring or various combinations thereof. Variations of the data diode include, but are not limited to, the following examples.

With reference to FIG. 3, two microprocessors 302 and 304, two Ethernet ports 306 and 308, and a shared memory 310 act as a stand-alone device in a first example of the data diode 300 using commercially available components. In this example, the write-lines 312 are disconnected 314 from the lower level CPU (central processing unit) 308 to the shared memory 310, thus ensuring one-way communications from the higher level critical asset such as Higher Level Host 316 to the lower one, Lower Level Host 318. More detailed descriptions of the hardware and software are given later in this document.

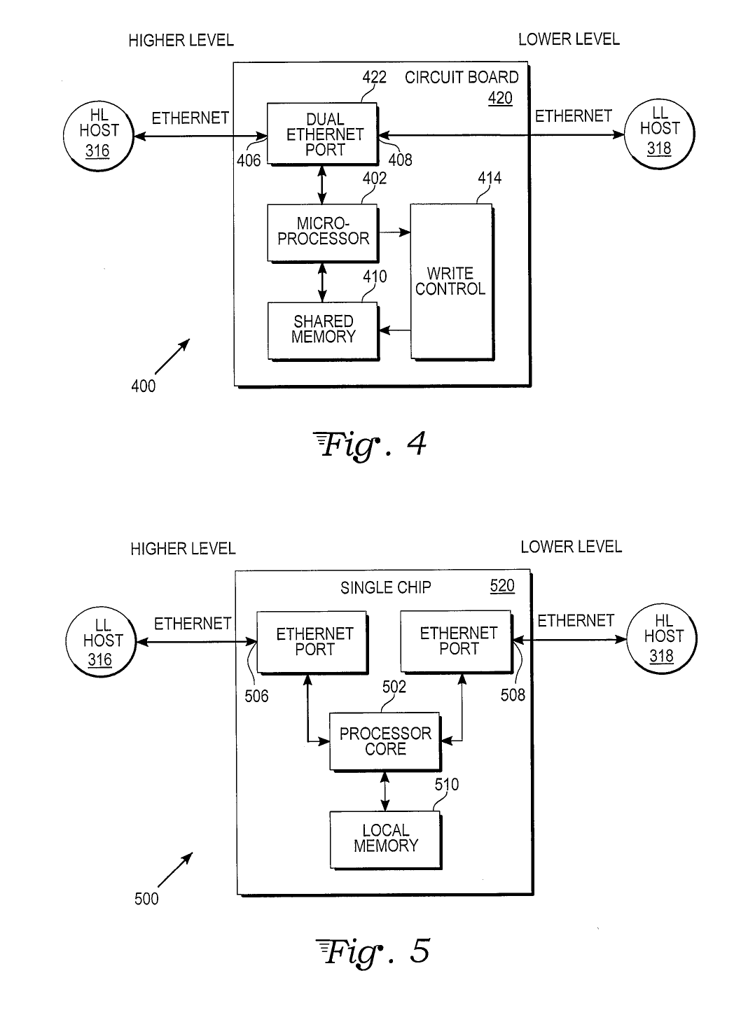

With reference to FIG. 4, a second example of a data diode 400 as a variation of the data diode 300 of FIG. 3 has one microprocessor 402, two Ethernet ports 406 and 408 and a shared memory 410, acting as a stand-alone device. A board 420 with a dual port Ethernet chip 422, or separate Ethernet chips (not shown), controlled by one microprocessor 402 and with shared memory 410 provides a further implementation of the data diode 400 as a board design.

With reference to FIG. 5, a third example of a data diode 500 as a variation of the data diode 300 of FIG. 3 has one microprocessor 502 with two Ethernet ports 506 and 508 and local memory 510, acting as a stand-alone device. A dual Ethernet port microprocessor or microcontroller may implement the data diode as a system on chip (SoC) or single chip 520 solution, or as a board design. However, if a standard processor core with integrated memory is used, the write-lines to local memory may not be disconnectable, and the one-way communication may be implemented with software controls, with the LED or other indicator (not shown, but see FIG. 3) controlled by software. Such an indicator may be activated by a software controlled processor, controller or peripheral port bit, the active state of the indicator showing that a write to shared memory is prevented by software control for lower level tasks.

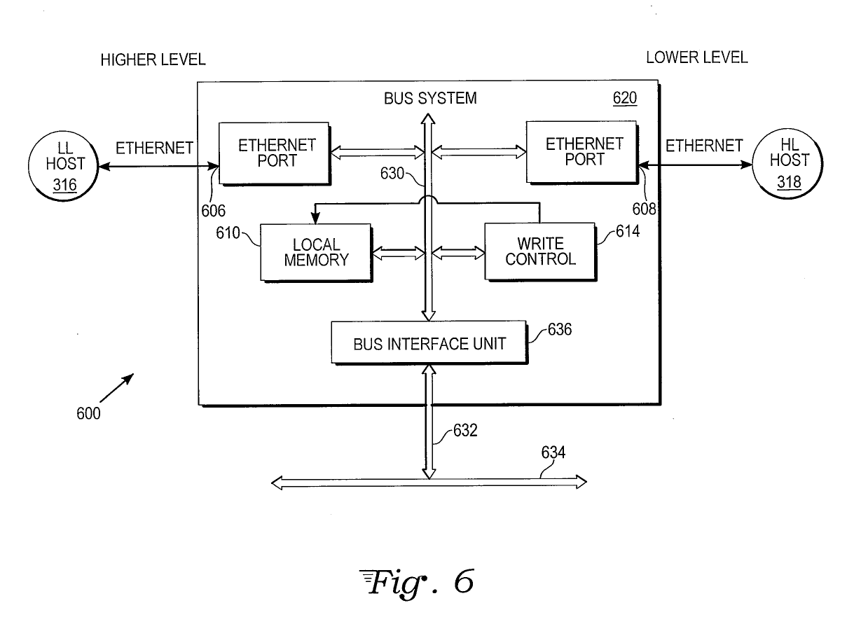

With reference to FIG. 6, a fourth example of a data diode 600 as a variation of the data diode 300 of FIG. 3 has two Ethernet ports 606 and 608 and a local memory 610 acting as a bus-based device 620. This example may include designs that are part of a larger bus-based design with a card cage, power supply, CPU boards, peripheral boards and other system components. Custom-designed boards for a vendor-specific product may could include a separate microprocessor (or not), separate shared memory (or not), and separate software (or not). A Bus Interface Unit (BIU) 636 may be included in the bus system 620 to connect a local bus 630, as used for communication with internal or local components of the data diode 600, with an external system bus 634 via an external bus connection 632. The data diode 600 implements the memory bridge 200 concept and the one-way communications, which may be shown by an LED or other indicator 322 as in FIG. 3.

Continuing the reference to FIG. 3, the electronic data diode 300 or eDD is a small, compact cyber-security device. The data diode 300 is shown as having Ethernet connections 324 and 326, although connections to other types of networks may be used along with corresponding types of network port chips, integrated circuit modules or boards. An ARM microprocessor architecture or other suitable architecture may be used in the data diode 300 or variation thereof.

The defense-in-depth design includes:

two separate microprocessors 302 and 304 that are interconnected through shared memory 310

a highly reliable realtime operating system (RTOS) 342 and 344 such as SafeRTOS, running on both microprocessors 302 and 304, that has been TUV certified to safety integrity level 3 (SIL level 3)

a hardware protection circuit 314 on the lower level that disables the write lines 312 to shared memory 310, including an LED or other indicator 322 that is ON when the write lines 312 to shared memory 310 are physically disconnected

a memory protection unit (MPU) in each microprocessor that provides hardware-based access controls to specific memory segments

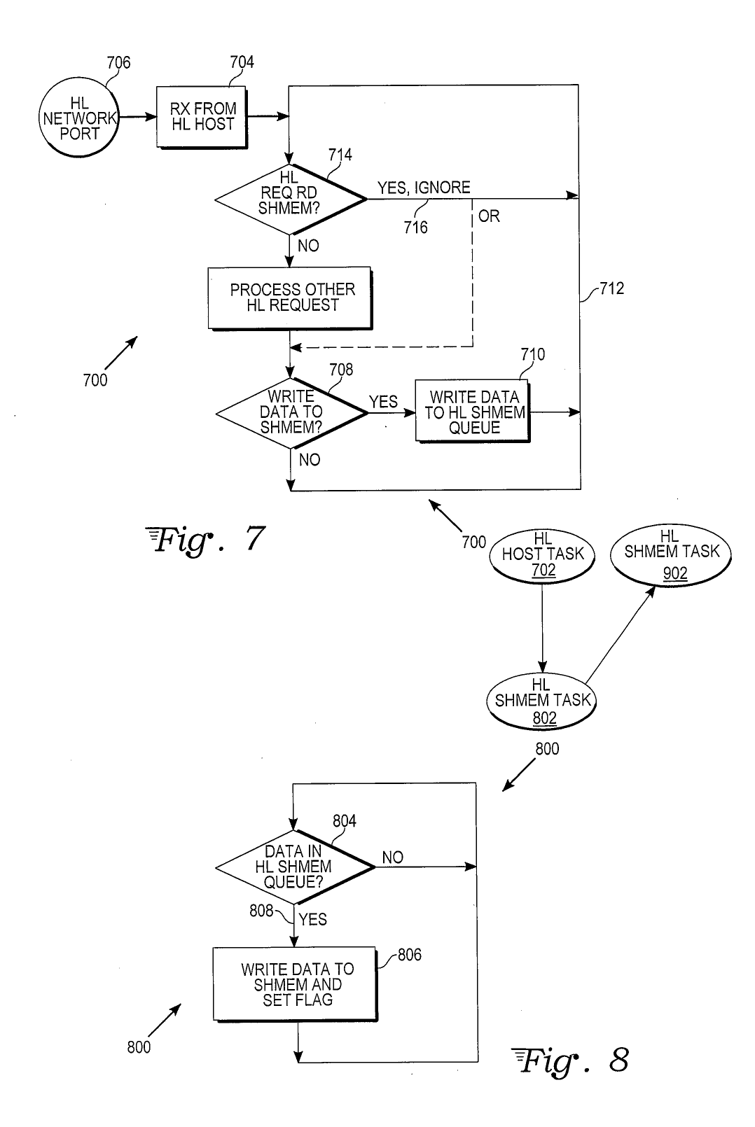

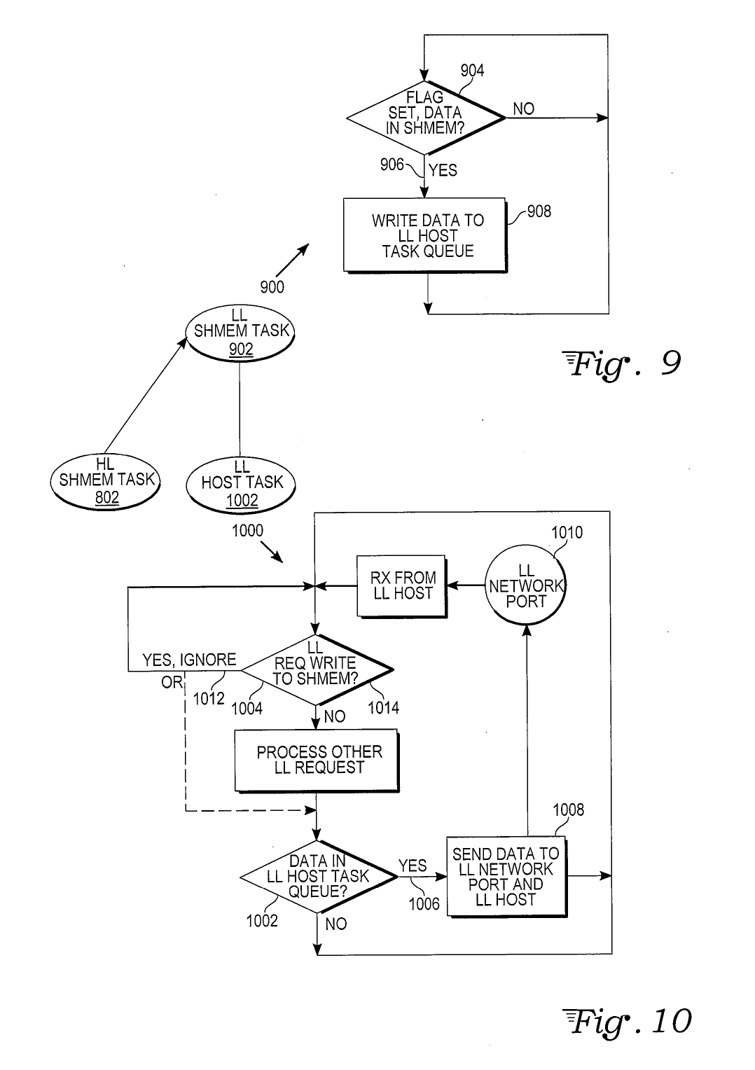

separate software tasks 702, 802, 902 1002 of FIGS. 7-10 and others, controlled by SafeRTOS, that run independently such that the failure of one task does not compromise the integrity of the other tasks

site-specific software that can be installed to allow the use of industry standard protocols (such as MODBUS TCP), data encryption, and proprietary protocols while still meeting the most demanding cyber-security requirements

monitoring tasks in both microprocessors to maintain the reliability of the total system

The eDD device hardware design may be based on a commercially available microprocessor and development kit or other hardware. A small printed circuit board 320 of FIG. 3 has been designed which includes the two microprocessors 302 and 304, the shared memory 310, the Ethernet connectors 324 and 326, the LED monitoring circuit 322 and the connection for an (optional) LCD (liquid crystal display) touch screen 346 and graphic display (not shown). The PCB (printed circuit board) fits into a compact enclosure for easy installation and maintenance. A separate power supply (not shown), similar to those used with laptop computers is used to provide the DC power. The (optional) LCD touch screen 346 is attached to the higher level micro-processor 302 to provide system administration functions and diagnostic information. Other input or output devices may be used.

With reference to FIGS. 7-10, the software design 700, 800, 900, 1000 and description below, of the first example of the data diode 300 uses the microprocessor protections, a shared memory region and the highly reliable real-time operating system (SafeRTOS) to control the data flow between the processors 302 and 304. With these components a “protected memory” area is constructed such that the software in the system can only access “allowed” areas of that memory. Access controls include read, read/write, and execute permissives or permissions appropriate to and for privileged and nonprivileged users (i.e. the higher level and lower-level users respectively). These controls provide a secure software “bridge” between two external systems located in the adjoining levels of the defensive model of R.G. 5.71. Using the defense-in-depth strategies (described above), a highly reliable data diode 300, or one-way communication, is achieved.

Although an example is given of software for a data diode 300 having two processors 302 and 304, software, firmware and/or hardware may be devised for systems having at least one processor such as single processor, dual processor, multiprocessor, parallel processors or bit slice systems and so on. Portions of the software may be implemented as in-line code or multithreaded applications, and with various branching or orderings of routines. Tasks may be divided up independently or synchronized, and interrupt driven or polling driven. Further, in variations tasks may be implemented in firmware or hardware.

The site-specific software 700 and 800 implemented on the higher level microprocessor 302 performs the sending and receiving of data to the higher level external device 316, the data conversion (if any), and storage in the protected memory 310: The site-specific software 900 and 1000 on the non-privileged or lower level side reads the protected memory 310 and transmits the data to the lower level external device 318. All of the custom software is controlled and scheduled by the SafeRTOS operating system to ensure that the one-way communication is fast, reliable, and trustworthy.

On power-up, the following steps are executed for the higher level CPU (HCPU) 302:

1. Execute the boot code to initialize the CPU 302 and any attached devices such as the higher level Ethernet port 306. In a variation, the higher level Ethernet port 306 is initialized by the higher level HOSTtask 702.

2. Setup the access controls for shared memory regions using the hardware memory protection (MPU) if available.

3. Initialize SafeRTOS.

4. Initialize the SHMEMtask (shared memory task) 802 to control access to shared memory 310 (read and write) by defining the memory regions and addresses that are controlled by SafeRTOS.

5. Initialize the SafeRTOS queues for intertask communications.

6. Initialize and activate the HOSTtask 702 for the Ethernet connection 324 to the higher level host 316.

7. Initialize and activate the MONITORtask to monitor the health of the HCPU devices and software.

8. Initialize and activate the DISPLAYtask to send data to the display 346.

9. Initialize and activate the TOUCHtask to read data from the touchscreen 346 (if the LCD display is installed).

Once the tasks and queues are initialized and activated, the HCPU 302 is ready for communications with the higher level host 316. The following paragraphs describe the SafeRTOS tasks identified above.

1. The HOSTtask 702 waits for data from the host or requests data from the host (application dependent). Data or requests from the higher level host 316 are received 704 from the higher level network port 706 e.g. the higher level Ethernet port 306. When data is received 808, the data is processed 708 and sent 710 to the higher level SHMEMtask queue. The HOSTtask then returns 712 to wait for more data from the host 316.

2. The SHMEMtask 802 waits 804 for data in its queue; when data is received, the data is written 806 to shared memory 310 and the task sets 806 a flag in shared memory to show that new data is available.

3. The MONITORtask waits for a preset time and then checks on the “health” of the tasks, devices, memory and other system resources. The results are sent to the DISPLAYtask.

4. The DISPLAYtask waits for any updates in its queue then updates any human interface devices such as an LCD 346 or other type of display.

5. The TOUCHtask waits for data in its queue which is due to the user touching the LCD touch screen 346 or a touchpad. The touch point is processed and the appropriate action taken. Other input devices, if present, may be processed for input by appropriate tasks.

On power-up, the following steps are executed for the lower level CPU (LCPU) 304:

1. Execute the boot code to initialize the CPU 304 and any attached devices such as the lower level Ethernet port 308. In a variation, the lower level Ethernet port 308 is initialized by the lower level HOSTtask 1002.

2. Setup the access controls for shared memory 310 regions for the hardware memory protection unit (MPU) if available.

3. Initialize SafeRTOS.

4. Initialize the SafeRTOS task to control access to shared memory 310 (read and write)—(SHMEMtask). Define the memory regions/addresses that are controlled by SafeRTOS.

5. Initialize the SafeRTOS queues for intertask communications.

6. Initialize and activate the task for the Ethernet connection 326 to the lower level host 318 (HOSTtask 1002).

7. Initialize and activate the task to monitor the health of the LCPU devices and software (MONITORtask).

Once the tasks and queues are initialized and activated, the LCPU 304 is ready for communications with the lowerlevel host 318.

1. The SHMEMtask 902 polls 904 the flag in shared memory looking for a change that signifies new data is available; when new data is available 906 it is read and put in the queue 908 for the HOSTtask 1002.

2. The HOSTtask 1002 waits 1002 for data in its queue or for communications 1004 from the host 318. When data is received in the queue 1006, the data is processed and sent 1008 to the lower level host 318 via the lower level network port 1010 e.g. the lower level Ethernet port 308.

3. The MONITORtask waits for a preset time and then checks on the “health” of the tasks, devices, memory and other resources. The results are used to control the link to the host by sending control messages to the HOSTtask 1002.

With reference to FIG. 3 and FIGS. 7-10, a typical data transfer is illustrated. Data being transferred from the higher level host 316 to the lower level host 318 travels via the shared memory 310 of the data diode 300 or variation thereof. Such data is handled in sequence by the higher level HOST task 702, the higher level Shared Memory task 802, the lower level Shared Memory task 902 and the lower level HOST task 1002.

The higher level HOST task 702 operates in a software 700 on the higher level processor 302. The higher level HOST task 702 receives 704 the data from the higher level host 316 at the higher level processor 302 from the higher level network port 306 and 706. The higher level HOST task 702 then writes 710 the data to a higher level queue.

For an added level of security, the higher level HOST task 702 ignores 716 or declines any request from the higher level network port 306 or 706 i.e. from the higher level host 316 to read the shared memory 310 or otherwise read any data provided by the lower level processor 304 or originating from the lower level host 318. Variations of the software 700 may implement the step of ignoring 716 such a request by branching back to examine a new request 714 or by continuing onward to process any write request to Shared Memory 708.

The higher level Shared Memory task 802 operates in a software 800 on the higher level processor 302. The higher level Shared Memory task 802 writes 806 the data from the higher level processor to the shared memory 310 in response to receiving the data at the higher level processor 302, by detecting the presence of the data in the higher level Shared Memory queue 804. The higher level Shared Memory task 802 sets a flag in the shared memory in response to writing the data from the higher level processor 302 to the shared memory 310.

The lower level Shared Memory task 902 operates in a software 900 on the lower level processor 304. The lower level Shared Memory task 902 determines, at the lower level processor 304 by polling the flag, that the flag has been set and the data has thus been written to the shared memory 310 by the higher level processor 302. The lower level Shared Memory task 902, in response to determining that the data has been written to the shared memory by the higher level processor, reads the data from the shared memory 310 into the lower level processor 304, in which the lower level Shared Memory task 902 is operating. The lower level Shared Memory task 902 then writes the data to the lower level HOST task queue 908.

The lower level HOST task 1002 operates in a software 1000 on the lower level processor 304. The lower level HOST task 1002, in response to data being written to the lower level HOST task queue 1006, writes or sends the data from the lower level HOST task queue to the lower level network port 1010 and 308 and onward to the lower level host 318. Thus, the lower level Shared Memory task 902 and the lower level HOST task 1002 perform the combined action of sending the data from the lower level processor 304 to the lower level network port 308 and 1010 in response to reading the data to the lower level processor 304.

For an added level of security, the lower level HOST task 1002 declines or ignores 1012 any request 1014 from the lower level network port 1010 or 308, i.e. the lower level host 318, to the lower level processor 304 to write to the shared memory 310. Variations of the software 1000 may implement the step of ignoring 1012 such a request by branching back to examine a new request 1014 or by continuing onward to process 1002 any sending 1008 of data from the lower level HOST task queue 1002 to the lower level network port 1010.

From a more coarse-grained viewpoint, the higher level HOST task 702 performs the act of receiving the data from the higher level network port 706. The higher level Shared Memory task 802, the lower level Shared Memory task 902 and the lower level HOST task 1002 perform the act of sending the data to the lower level network port 1010 in response to receiving the data. As discussed with reference to FIGS. 4-7, the tasks 702, 802, 902 and 1002 may operate on a data diode having at least one processor, such as on a single processor 402 or 502, may operate on a data diode having a higher level processor 302 and a lower level processor 304, or may operate on a system with 1, 2 or several processors such as a bus-based system, or even a multiprocessor system on one or more boards.

The act or characteristic of declining or ignoring any request from a lower level network port or host to write to the shared memory may be implemented in software or hardware or a combination thereof. A software implementation may include writing software and verifying that the software does not contain any path whereby such a request could result in such a write, or verifying that the software will branch around such a request. A software implementation may include defining address ranges where reading is or is not allowed, or where writing is or is not allowed, for a higher level or lower level task or for higher level or lower level processors. A hardware implementation may include the use of a memory management unit, a memory protection unit or a memory write disable circuit as discussed. A combination of software and hardware may implement such a feature, as when a hardware circuit or module such as a custom circuit, a memory management unit or a memory protection unit is addressable by software or controllable by a port bit under software control and so on. For example, a lower level task write to the shared memory may be disabled by software which disallows such a write, by hardware that disables a lower level processor from writing to the shared memory or that is switchable when a single processor hands off from a higher level task to a lower level task, or by hardware that is controlled by a higher level task or a higher level processor.

The data diode 300, 400, 500 or 600 of FIGS. 3-6 may be used for various communication protocols. All of the standard communication protocols (TCP/IP, UDP, MODBUS TCP, etc) use a two-way communication protocol to make and maintain a connection. In order to implement a one-way communication, the eDD device breaks the two-way communication by inserting a complementary pair of equivalent software agents separated by the shared memory “bridge”. The hosts on each side of the eDD device still act as though the original two-way communications are in place.

For a TCP/IP connection in which the higher level host is the server and the lower level host is the client, the HCPU must be configured as a client and the LCPU as a server.

For a TCP/IP connection in which the higher level host is the client and the lower level host is the server, the HCPU must be configured as a server and the LCPU is a client.

For a UDP connection, one configuration that is meaningful is that the higher level host is the server. Therefore the HCPU is a client and the LCPU becomes the UDP server for all the lower-level clients.

For a MODBUS TCP connection, the higher level side is the Modbus master and the lower level side is the Modbus slave.

A UDP example is given below. Consider an existing UDP connection between a level 4 control system and a level 3 computer. Assume the Level 4 control system is configured as a UDP server which broadcasts data from e.g. higher level host 316 to all attached clients e.g. lower level host 318. The data contents and frequency of the data transfers are defined and documented in the Level 4 system. The Level 3 system only needs to know the IP address and the data contents of the UDP datagrams.

Although this appears to be a one-way communication, there are still control signals that go between the two systems that establish and maintain the ports on both systems. By connecting an eDD device between the Level 4 control system and the Level 3 computer system, the two-way communications are “broken” and separate communications paths are established as connected by the memory bridge.

The Level 4 control system is already operating as a UDP server. The HCPU of the eDD establishes the UDP link to the Level 4 system and starts receiving datagrams from the Level 4 host 316. As each datagram is received, it is re-written to shared memory 310 and a flag is set in shared memory 310.

Concurrently, and completely independently, the LCPU configures itself as a UDP server and waits for a connection request from the Level 3 computer system. When a request is received and accepted, the LCPU 304 polls the shared memory 310 looking for a new datagram. The polling frequency should be faster than the datagram updates or data will be lost. When a new datagram is read from shared memory, it is re-transmitted to the Level 3 computer. The polling frequency can be adjusted such that delays due to the re-transmission of the datagrams can be on the order of milliseconds.

A TCP/IP example is given below. For a TCP/IP connection, the same type of initialization occurs on both the HCPU and the LCPU and any data transfers from the higher level to the lower level would occur as before. However, with TCP/IP there is a possibility that the protocol includes a read request 714 from the Level 4 host 316. If this read request 714 includes data from the Level 3 computer, that request is illegal and not allowed 716. The application software should be changed to eliminate any read requests from the higher level host. On the lower side, any write requests 1014 can also be ignored 1012 since they will never go anywhere. In these types of cases, the software on both ends of the TCP/IP connection may need to be modified to eliminate the use of two-way communications.

A MODBUS TCP example is given below. MODBUS TCP is a popular two-way protocol used in many industrial applications to connect Level 4 control systems, such as PLCs, to other computing platforms operating at Level 3. Typically, the Level 4 device would be configured as the MODBUS slave, and the Level 3 system would be the MODBUS master. The master then sends read (or write) requests to the slave, which collects the data requested and returns it in data packets defined by the protocol. In this configuration, the master is “in charge” of the data transfers and must continually send requests for data and then read the responses. The MODBUS TCP protocol is usually a very active two-way communications link.

In order to make this two-way protocol work in a one-way communications link, the eDD device is inserted between the two systems. The MODBUS master on the higher level side of the eDD (the HCPU 302) initiates all the read requests to the Level 4 host 316, processes the responses, and writes the data to the protected shared memory 310 area. The software on the lower level side of the eDD device (the LCPU 304) then reads the data from shared memory 310 and acts like a MODBUS slave to re-transmit the data via TCP/IP to the Level 3 host 318.

Issues relating to the Real-time Operating System (RTOS) are discussed below. A real-time operating system (RTOS) may be used in an example of a data diode 300, however an RTOS is not an absolute requirement for the one-way communication. A simple application, such as a UDP connection, could be constructed and tested without an RTOS. For high-integrity applications (such as ones in nuclear power plants), it is necessary to document and demonstrate that all the software in the device is of the highest quality and that software-related failure modes have been addressed. Using a highly reliable RTOS provides a solid base on which to build sophisticated applications.

If a proprietary operating system (O/S) is used, real-time or otherwise, it must be shown to be highly reliable and appropriate for the application. It is doubtful that a black box O/S, such as Windows, would be acceptable for use in high integrity applications, such as a nuclear power plant. High-integrity RTOS products from various vendors could be used in different examples of the data diode.

There are “open-systems” operating systems that can be used as a basis for a high integrity application, but generally the burden of proof that the open-source software is highly reliable falls on the application developer, not on the open-source developer. Further, maintaining configuration controls on an open-source system is a burden on the application developer.

The open-source RTOS, SafeRTOS, is used in this application because one developer (Wittenstein Systems) has created a subset of the available open-source FreeRTOS software. Wittenstein has used this subset to obtain TUV certification for a Safety Integrity Level (SIL) of three (the second-highest level possible). Although the NRC does not recognize SIL levels in its regulations, software with a SIL 3 should be acceptable (with the proper documentation) for use in a nuclear power plant.

Issues relating to Access Control Lists (ACL) are discussed below. Access control lists have been used in computing systems for decades to control access to computing systems (e.g. login IDs), components (e.g. areas of memory), and software (i.e. file systems, files, etc.). Many high integrity system use some form of ACLs for increased security and integrity. ACLs may be used as a portion of a defense-in-depth strategy to ensure the security of a system using the data diode device. For an example of the data diode, the shared memory access controls may be implemented using the Memory Protection Unit (MPU) of the microprocessor and/or the implicit controls imposed by the RTOS tasks.

Issues relating to the shared memory bridge with restricted write capability are discussed below. A significant feature of at least one example of the data diode is the hardware design of the shared memory in which the write-enable lines from the lower-level microprocessor to the shared memory are physically disconnected. With such a design, there is no possibility that data from the lower level can be transferred to the higher level through the shared memory bridge. Further, an indicator such as an LED is included in the data diode 300 that shows the hardware write-lines to the shared memory from the lower-level microprocessor are disconnected. Such an indicator may be included in other variations of the data diode 300.

With reference to FIGS. 3, 4 and 6 a memory write disable circuit 314, 414 or 614 for controlling write access to the shared memory 310, 410 or 610 respectively is shown. Various memory control, write control, memory access and other types of write disabling circuits may be devised by a person skilled in the art, as suitable for implementing the disclosed features of the data diode 300.

In a first example of a memory write disable circuit, at least the write line from a lower level processor to the shared memory is severed or deleted from the circuit board or System on Chip implementing the data diode 300 or a variation thereof. Equivalently, the circuit board or System on Chip is implemented lacking or without such a write line or lines. In this example, the lower level processor is unable to write to the shared memory as a result of not having a write line to the shared memory. An LED or other indicator, if implemented, may be kept continuously in an active state, as the write lines from the lower level processor have no circuit connection to the shared memory.

In a second example of a memory write disable circuit, the write line or lines from a lower level processor to the shared memory are gated by a port bit or other software controllable line from a higher level processor. The higher level processor sets or clears the respective bit to enable or disable the lower level processor from writing to the shared memory by enabling or disabling the gated write line from the lower level processor to the shared memory.

In a third example of a memory write disable circuit an off-line mode or a run mode of at least one processor in the data diode 300, 400, 500 or 600 or other variation is detected or declared e.g. by a software controllable port bit or other means known in the art, and the mode is used to gate or otherwise control memory writes to the shared memory.

In a fourth example of a memory write disable circuit, a memory protection unit (MPU) or a memory management unit (MMU) is initialized with addressing, read permission, write permission and other relevant information, and controls reading and writing accesses accordingly. Such a circuit may be implemented as an available integrated circuit, an available IC module, or custom-designed circuitry, and may be under software, hardware or firmware control.

In a fifth example of a memory write disable circuit, a state machine and/or logic gating enables writing to shared memory under certain circumstances and disables writing to shared memory under further circumstances.

A situation in which switchable writing enabling or disabling to the shared memory is useful is when the higher level host requires a configuration file to run properly. This configuration file is generated periodically e.g. once per month or other time period based on current operating conditions. The calculation of this configuration file occurs on the lower level host. If the lower level host cannot send data to the upper level host, system operation may be hindered. One solution is to have the data diode or eDD device allow the LCPU to write the file to shared memory under strict software controls (i.e. running in offline mode with proper administrative oversight). When the device is turned back on to the run-mode, then the software and/or hardware prevents any writes to shared memory from the LCPU. In this case the write-line LED would be OFF during the offline mode and ON during run mode.

As discussed with reference to FIG. 3 and elsewhere, an indicator may be added to show that write to shared memory from a lower level processor 304 or from or as a result of a lower level task is disabled. An LED, a portion of a display, an audio device such as a speaker or a buzzer or other notification device may be used as an indicator. The indicator may be under hardware or software control, and may be hardwired, switchable, state or task dependent or otherwise devised by a person skilled in the art. In one example, where a write line to the shared memory is controlled by a write disable circuit, the indicator may be driven by the controllable write line itself or by a buffered version of the controllable write line. In further examples, the indicator may be controlled by a port bit from a single processor or from a higher level processor or a lower level processor. In a still further example, the indicator may be controlled by a watchdog circuit monitoring signals and functions of the data diode. An LED or other indicator may be hardwired active, for example where a write line from a lower level processor to the shared memory is severed permanently. In a variation, the indicator may be or include a warning device that sets or triggers a flag or an alarm if a write to the shared memory from a lower level processor or task occurs.

Aspects of custom software are discussed below. Examples of the eDD device can accommodate custom software on either the high-level or the low-level microprocessor. This flexibility allows the device to adapt to the requirements of the application. Very high integrity applications could add data encryption, special protocols, access controls, etc. to ensure protection against cyber attacks. As the attacks become more sophisticated, so would the eDD protection device.

Aspects of Software Quality Assurance (SQA) are discussed below. As with any software-based device for high integrity applications, the quality of the embedded software is a serious concern. The software in an example of the eDD device (including any custom software) may need to meet the SQA requirements of the nuclear industry that are based on IEEE software standards. Documentation provided with an example of the EDD device may include a Software Requirements Specification (SRS), a Software Design Description (SDD), a Software Verification and Validation Plan (SVVP), V&V test procedures, and a final V&V report (SVVR). Through the commercial dedication process defined in US Regulatory Guide 1.152, it is also be possible to dedicate the eDD to serve as a communications interface between a class 1E safety system and a non-safety system in a US nuclear power plant.

The various examples and variations of the memory bridge 200 and the data diode 300 provide a one-way communication path and protect a higher level digital asset against attacks from a lower level. The disclosed devices and methods may be useful in network applications involving primarily one-way communication albeit with some two-way control signals that may be handled accordingly, single channel TCP/IP transfers, portions of fully featured Web servers, broadcast one way communication, prearranged or simulated two-way communication and other areas.

What is claimed is:

1. A network security device comprising:
a higher level network port connectable to a first network;
a lower level network port connectable to a second network; and
at least one processor connected to the higher level network port and the lower level network port and connectable to a shared memory;
wherein the at least one processor is configured to:
send a data to the lower level network port via the shared memory in response to receiving the data from the higher level network port; and
decline any request from the lower level network port to the at least one processor to write to the shared memory.

2. The network security device of claim 1 wherein the at least one processor is further configured to decline any request from the higher level network port to the at least one processor to read the shared memory.

3. The network security device of claim 1 wherein the at least one processor includes a higher level processor and a lower level processor.

4. The network security device of claim 3 wherein declining any request from the lower level network port to the at least one processor to write to the shared memory includes disabling the lower level processor from writing to the shared memory.

5. The network security device of claim 3 wherein sending the data to the lower level network port includes:
writing the data from the higher level processor to the shared memory in response to receiving the data at the higher level processor from the higher level network port;
reading the data from the shared memory to the lower level processor in response to the data being written to the shared memory by the higher level processor; and
sending the data from the lower level processor to the lower level network port in response to reading the data from the shared memory to the lower level processor.

6. The network security device of claim 1 further comprising:
a memory write disable circuit connected between the at least one processor and the shared memory; and
the memory write disable circuit disabling a lower level task write to the shared memory.

7. The network security device of claim 6 wherein the memory write disable circuit is controlled by the at least one processor executing a higher level task or by a higher level processor.

8. The network security device of claim 6 wherein the memory write disable circuit is at least partially controlled by the at least one processor being in an off-line mode or in a run mode.

9. The network security device of claim 1 further comprising an indicator wherein an active state of the indicator is consistent with a lower level task write to the shared memory being disabled.

10. The network security device of claim 9 wherein the indicator includes one of an LED, a portion of a display or a sound producing device.

11. A network security device comprising:
a higher level network port connectable to a first network;
a lower level network port connectable to a second network;
a shared memory;
a higher level processor connected to the higher level network port and the shared memory; and
a lower level processor connected to the lower level network port and to the shared memory and at least conditionally disabled from writing to the shared memory;
wherein the higher level processor and the lower level processor are configured to execute a method including:
receiving a data at the higher level processor from the higher level network port;
writing the data from the higher level processor to the shared memory in response to receiving the data from the higher level network port at the higher level processor;
reading the data from the shared memory to the lower level processor in response to the data being written to the shared memory by the higher level processor; and
sending the data from the lower level processor to the lower level network port in response to reading the data from the shared memory to the lower level processor.

12. The network security device of claim 11 wherein the higher level processor is further configured to ignore any request from the higher level network port to the higher level processor to read the shared memory.

13. The network security device of claim 11 wherein a hardwiring prevents the lower level processor from writing to the shared memory.

14. The network security device of claim 13 wherein an indicator is hardwired in an active state.

15. The network security device of claim 11 wherein the lower level processor being at least conditionally disabled from writing to the shared memory includes a write line from the lower level processor to the shared memory being absent on a circuit board or an integrated circuit containing the lower level processor and the shared memory.

16. The network security device of claim 11 wherein the lower level processor being at least conditionally disabled from writing to the shared memory includes the lower level processor being configured to prevent writing to the shared memory during a run mode.

17. The network security device of claim 11 wherein the lower level processor being at least conditionally disabled from writing to the shared memory includes a memory write disable circuit enabling a lower level processor write to the shared memory in an off-line mode and disabling the lower level processor write to the shared memory in a run mode.

18. The network security device of claim 11 further comprising an indicator, the indicator being in an active state in response to the lower level processor being disabled from writing to the shared memory.

19. A method for one way communication in a computer network, the method comprising:
receiving a data at an at least one processor from a higher level network port;
sending the data from the at least one processor to a lower level network port in response to receiving the data at the at least one processor; and
ignoring any request from the lower level network port to the at least one processor to write to a shared memory;
wherein at least one of receiving the data or sending the data is via the shared memory.

20. The method of claim 19 further comprising ignoring any request from the higher level network port to the at least one processor to read the shared memory.

21. The method of claim 19 wherein ignoring any request from the lower level network port to the at least one processor to write to the shared memory includes physically disconnecting a write line from a lower level processor to the shared memory.

22. The method of claim 19 wherein ignoring any request from the lower level network port to the at least one processor to write to the shared memory includes controlling a memory write disable circuit connected between the at least one processor and the shared memory.

23. The method of claim 19 wherein ignoring any request from the lower level network port to the at least one processor to write to the shared memory includes the at least one processor being configured to prohibit a lower level task from writing to the shared memory.

24. The method of claim 19 further comprising activating an indicator to show a write from a lower level task or a lower level processor to the shared memory is disabled.

25. A method for securely controlling communications in a computer network, the method comprising:
receiving a data at a higher level processor from a higher level network port;
writing the data from the higher level processor to a shared memory in response to receiving the data at the higher level processor;
reading the data from the shared memory to a lower level processor in response to the data being written to the shared memory by the higher level processor;
sending the data from the lower level processor to a lower level network port in response to reading the data to the lower level processor; and
declining any request from the lower level network port to the lower level processor to write to the shared memory.

26. The method of claim 25 further comprising declining any request from the higher level network port to the higher level processor to read the shared memory.

27. The method of claim 25 further comprising:
setting a flag in response to writing the data from the higher level processor to the shared memory; and
determining at the lower level processor that the data has been written to the shared memory by the higher level processor, by polling the flag.

28. The method of claim 25 wherein:
receiving the data at the higher level processor from the higher level network port includes writing the data to a higher level queue;
writing the data from the higher level processor to the shared memory in response to receiving the data at the higher level processor includes writing the data from the higher level queue to the shared memory;
reading the data from the shared memory to the lower level processor in response to the data being written to the shared memory by the higher level processor includes writing the data to a lower level queue; and
sending the data from the lower level processor to a lower level network port in response to reading the data to the lower level processor includes writing the data from the lower level queue to the lower level network port.

29. The method of claim 25 wherein declining any request from the lower level network port to the lower level processor to write to the shared memory includes disabling writing to the shared memory from the lower level processor.

30. The method of claim 25 wherein declining any request from the lower level network port to the lower level processor to write to the shared memory includes disconnecting a write line from the lower level processor to the shared memory.

31. The method of claim 25 wherein declining any request from the lower level network port to the lower level processor to write to the shared memory includes controlling a write disabling circuit connected between the lower level processor and the shared memory.

32. The method of claim 25 further comprising activating an indicator to show writing from the lower level processor to the shared memory is disabled.
